(19) United States
(12) Patent Application Publication
(10) Pub. No.: US 2012/0213693 A1
(43) Pub. Date: Aug. 23, 2012

(54) USE OF LIQUID HYDROGEN CHLORIDE AS REFRIGERANT IN PROCESSES FOR PREPARING CHLORINE

(75) Inventors: Hans-Jürgen PALLASCH, Kallstadt (DE); Heiner SCHELLING, Kirchheim (DE); Peter VAN DEN ABEEL, Brasschaat (BE); Till EINIG, Weinheim (DE)

(73) Assignee: BASF SE, Ludwigshafen (DE)

(21) Appl. No.: 13/371,910

(22) Filed: Feb. 13, 2012

Related U.S. Application Data
(60) Provisional application No. 61/444,156, filed on Feb. 18, 2011.

(51) Int. Cl. C01B 7/04

(52) U.S. Cl. 423/502

(57) ABSTRACT

This invention relates to a process for preparing chlorine from HCl and a method of using liquid HCl to cool and optionally liquefy chlorine in the process. The process involves introducing at least one HCl-containing stream and an oxygen-containing stream into an oxidation zone and catalytically oxidizing the HCl to chlorine, contacting the chlorine with aqueous HCl with partial separation of water and HCl to yield a gas stream, drying the gas stream to yield an essentially water-free gas stream, which is compressed and cooled to give an at least partially liquefied stream, and separating the liquefied stream into a gas stream and a liquid stream which is separated into a chlorine stream, such that cooling and partial liquefaction of the gas stream is effected by indirect heat exchange with a liquid HCl stream, resulting in some of the liquid HCl stream vaporizing to form a gaseous HCl stream.

The invention relates to a process for preparing chlorine from hydrogen chloride, in which liquid hydrogen chloride is used as refrigerant, and also the use of liquid hydrogen chloride as refrigerant in processes for preparing chlorine.

In many chemical processes in which chlorine or downstream products of chlorine, e.g. phosgene, are used, hydrogen chloride is obtained as by-product. Examples are the preparation of isocyanates, of polycarbonates and the chlorination of aromatics. The hydrogen chloride obtained as by-product can be converted back into chlorine by electrolysis or by oxidation by means of oxygen. The chlorine prepared in this way can then be reused.

In the process of catalytic oxidation of hydrogen chloride developed by Deacon in 1868, hydrogen chloride is oxidized to chlorine by means of oxygen in an exothermic equilibrium reaction. Conversion of hydrogen chloride into chlorine enables chlorine production to be decoupled from sodium hydroxide production by chloralkali electrolysis. Such decoupling is attractive since the world demand for chlorine is growing more quickly than the demand for sodium hydroxide.

In all known processes for oxidizing hydrogen chloride by means of oxygen, the reaction gives a gas mixture which comprises not only the target product chlorine but also water, unreacted hydrogen chloride and oxygen and also possibly further secondary constituents such as carbon dioxide and inert gases. To obtain pure chlorine, the product gas mixture is cooled after the reaction to such an extent that the water of reaction and hydrogen chloride condense out in the form of concentrated hydrochloric acid. The hydrochloric acid formed is separated off and the remaining gas mixture is freed of residual water by scrubbing with concentrated sulfuric acid or by drying by means of zeolites. The now water-free gas mixture is subsequently compressed and cooled so that chlorine condenses out but oxygen and other low-boiling gas constituents remain in the gas phase. The liquefied chlorine is separated off and optionally purified further.

EP-A 0 765 838 discloses a process for working up the reaction gas composed of chlorine, hydrogen chloride, oxygen and water vapor which is obtained in the oxidation of hydrogen chloride, in which the reaction gas leaving the oxidation reactor is cooled to such an extent that water of reaction and hydrogen chloride condense out in the form of concentrated hydrochloric acid, the concentrated hydrochloric acid is separated off from the reaction gas and discharged and the remaining reaction gas which has been essentially freed of water and part of the hydrogen chloride is dried, the dried reaction gas composed of chlorine, oxygen and hydrogen chloride is compressed to from 1 to 30 bar and the compressed reaction gas is cooled and thereby mostly liquefied, with components of the reaction gas which cannot be condensed out being at least partly recirculated to the oxidation reactor.

To separate off the chlorine, the dried and compressed reaction gas mixture is liquefied in a chlorine recuperator configured as a flash cooler to a residual proportion of from about 10 to 20%. The liquid main chlorine stream separated off in the chlorine recuperator is subsequently after-purified in a distillation column in which the chlorine is freed of residual dissolved hydrogen chloride, oxygen and inert gases. The gas consisting essentially of hydrogen chloride, chlorine, oxygen and inert gases which is taken off at the top of the distillation column is recirculated to the compression stage. The gas components which are not condensed out in the chlorine recuperator, including the residual chlorine, are partly liquefied at a significantly lower temperature in an after-cooling stage. The remaining offgas composed of unreacted hydrogen chloride, oxygen and inert gases is recycled to the oxidation reactor. A substream of the recycled gas is separated off as purge gas stream and discharged from the process in order to prevent accumulation of impurities.

WO 2007/134716 and WO 2007/085476 describe the advantageous effect of the presence of HCl in the isolation of chlorine. In the process described in WO 2007/085476, the condensation stage for water and HCl is operated so that an advantageous amount of hydrogen chloride goes with the process gas via the drying stage into the compressor and the subsequent isolation of chlorine. In the process described in WO 2007/134716, part of the gaseous hydrogen chloride is taken off from the feedstream to the process and fed directly, by passing the other process stages, to the isolation of chlorine.

A process for preparing chlorine from hydrogen chloride is described in WO 2007/085476. The processes comprise the steps:
a) introduction of a stream a1 comprising hydrogen chloride and an oxygen-comprising stream a2 into an oxidation zone and catalytic oxidation of hydrogen chloride to chlorine, giving a product gas stream a3 comprising chlorine, water, oxygen, carbon dioxide and inert gases;
b) contacting of the product gas stream a3 with aqueous hydrochloric acid I in a phase contact apparatus and partial separation of water and hydrogen chloride from the stream a3, leaving a gas stream b comprising hydrogen chloride, chlorine, water, oxygen, carbon dioxide and possibly inert gases, with at least 5% of the hydrogen chloride comprised in the stream a3 remaining in the gas stream b;
c) drying of the gas stream b to leave an essentially water-free gas stream c comprising hydrogen chloride, chlorine, oxygen, carbon dioxide and possibly inert gases;
d) partial liquefaction of the gas stream c by compression and cooling, giving an at least partly liquefied stream d;
e) gas/liquid separation of the stream d into a gas stream el comprising chlorine, oxygen, carbon dioxide, hydrogen chloride and possibly inert gases and a liquid stream e2 comprising hydrogen chloride, chlorine, oxygen and carbon dioxide and optionally recirculation of at least part of the gas stream e1 to step a);
f) separation of the liquid stream e2 into a chlorine stream f1 and a stream f2 consisting essentially of hydrogen chloride, oxygen and carbon dioxide by distillation in a column, with part of the hydrogen chloride condensing at the top of the column and running back as runback into the column, as a result of which a stream f2 having a chlorine content of <1% by weight is obtained.

In step d), the dried gas stream c, which consists essentially of chlorine and oxygen and additionally comprises hydrogen chloride and inert gases (carbon dioxide, nitrogen), is compressed in a plurality of stages to from about 10 to 40 bar. The compressed gas is cooled to temperatures of from about −10 to −40° C.

The compressed and partly liquefied, two-phase mixture is finally fractionated in a mass transfer apparatus. Here, the unliquefied gas stream is contacted in countercurrent or in cocurrent with the liquid which consists essentially of chlorine and dissolved carbon dioxide, hydrogen chloride and oxygen. As a result, the unliquefied gases accumulate in the liquid chlorine until the thermodynamic equilibrium is reached, so that removal of inert gases, in particular carbon dioxide, can be achieved via the offgas from the subsequent chlorine distillation.

The liquefied chlorine, which generally has a chlorine content of >85% by weight, is subjected to a distillation at from about 10 to 40 bar. The temperature at the bottom is from about 30 to 110° C., and the temperature at the top is, depending on the hydrogen chloride content of the liquefied chlorine, in the range from about −5 to −8° C. and from about −25 to −30° C. Hydrogen chloride is condensed at the top of the column and allowed to run back into the column. As a result of the HCl reflux, virtually complete separation of chlorine is achieved and the chlorine loss is thereby minimized. The chlorine which is taken off at the bottom of the column has a purity of >99.5% by weight.

To generate low temperatures, refrigeration machines are generally used. Suitable refrigerants are fully halogenated hydrocarbons as are described, for example, in U.S. Pat. No. 5,490,390. Fully halogenated hydrocarbons are very unreactive. They do not undergo any chemical reactions with chlorine and other substances present in chlorine-producing plants in the case of leakages, which is a great advantage from a safety point of view. However, these substances have a high potential to damage the ozone layer when released into the atmosphere, and their use is therefore permitted only to a greatly restricted extent or is largely forbidden.

The only partially halogenated hydrocarbons used as substitute refrigerants are more reactive and therefore incur the risk of undesirable chemical reactions in the case of leakages in chlorine plants.

Ammonia is likewise a well-suited refrigerant for refrigeration machines. However, the direct use of ammonia for chlorine condensation does not come into question since in the case of leakages formation of NCl₃ can occur, and this can decompose explosively even in low concentrations.

One possibility for preventing direct contact of chlorine and refrigerant in the case of leakages is the use of safety heat exchangers equipped with double pipes and gap monitoring. A further possibility is the provision of an intermediate, closed secondary cooling circuit operated using an inert refrigerant, as described in U.S. Pat. No. 5,490,390. In the case of chlorine as material to be cooled, CO₂ is suitable as inert refrigerant.

It is an object of the invention to provide an improved process for preparing chlorine from hydrogen chloride, which process is advantageous from economic and safety points of view. A further object of the invention is to provide an alternative refrigerant for separating chlorine by condensation from the process gas streams of chlorine-producing plants.

The object is achieved by a process for preparing chlorine from hydrogen chloride, which comprises the steps:
a) provision of a liquid hydrogen chloride stream a as refrigerant stream;
b) introduction of at least one stream b1 comprising hydrogen chloride and an oxygen-comprising stream b2 into an oxidation zone and catalytic oxidation of hydrogen chloride to chlorine, giving a product gas stream b3 comprising chlorine, water, oxygen, carbon dioxide and inert gases;
c) contacting of the product gas stream b3 with aqueous hydrochloric acid in a phase contact apparatus and partial separation of water and hydrogen chloride from the stream b3, leaving a gas stream c comprising hydrogen chloride, chlorine, water, oxygen, carbon dioxide and possibly inert gases;
d) drying of the gas stream c to leave an essentially water-free gas stream d comprising hydrogen chloride, chlorine, oxygen, carbon dioxide and possibly inert gases;
e) partial liquefaction of the gas stream d by compression and cooling, giving at least partly liquefied stream e;
f) gas/liquid separation of the stream e into a gas stream 11 comprising chlorine, oxygen, carbon dioxide, hydrogen chloride and possibly inert gases and a liquid stream f2 comprising hydrogen chloride, chlorine, oxygen and carbon dioxide and optionally recirculation of at least part of the gas stream f1 to step b);
g) separation of the liquid stream f2 into a chlorine stream g1 and a stream g2 consisting essentially of hydrogen chloride, oxygen and carbon dioxide by distillation in a column,
   where the cooling and partial liquefaction of the gas stream d in step e) is effected by indirect heat exchange with the liquid hydrogen chloride stream a, resulting in at least part of the liquid hydrogen chloride stream a vaporizing and this part forming a gaseous hydrogen chloride stream a′.

In the cooling by indirect heat exchange, the hydrogen chloride stream a and the gas stream d do not come into direct contact with one another, which would have resulted in mixing of the streams. Rather, heat exchange is effected in a heat exchanger. This can have any construction. Suitable heat exchangers are, for example, shell-and-tube heat exchangers, U-tube heat exchangers, spiral or plate heat exchangers.

It has been found that HCl is particularly well-suited as material which is inert to chlorine for use as refrigerant in chlorine-producing plants.

HCl can be condensed relatively simply by condensation at from 10 to 25 bar using a conventional refrigeration plant at condensation temperatures of from −10 to −40° C.

The use of the hydrogen chloride which has liquefied in this way provides the “cold” required for the condensation of chlorine in the low-temperature range (temperature <20° C.) in a simple manner by vaporization. The vaporized HCl does not, depending on the operating state of the HCl oxidation plant, have to be circulated in its entirety, i.e. cooled again, optionally compressed and condensed, but can instead be passed on as gaseous starting material to the HCl-oxidation plant.

An advantage of HCl as operating medium is that HCl and chlorine do not undergo any chemical reactions in the case of a possible leakage in the heat exchanger.

A further advantage is that, corresponding to the vapor pressure curve of HCl, low temperatures can be achieved when HCl is vaporized. Thus, vaporization temperatures of HCl of −32, −42° C. and −51° C. are established at pressures of 10, 7 and 5 bar, respectively. Thus, chlorine can be completely condensed at a low pressure or in the presence of gases such as nitrogen, carbon dioxide, oxygen, argon and hydrogen. The chlorine partial pressures in the gas phase which can be achieved at the abovementioned temperatures of −32, −42° C. and −51° C. are 1.11, 0.71 and 0.45 bar, respectively.

In general, the pressure under which the liquid hydrogen chloride stream a is present is from 1 to 30 bar, preferably from 5 to 15 bar, and the temperature of the liquid hydrogen chloride is correspondingly from −80 to −10° C., preferably from −50 to −20° C.

The chlorine partial pressures which can be achieved at these low temperatures are particularly advantageous in the oxidation of hydrogen chloride by means of oxygen in the Deacon process, since there the condensation occurs in the presence of process and inert gases and at the same time a very complete separation of the chlorine from the remaining gases is desired. Firstly, the major part of the remaining, uncondensed gas stream is recirculated to the hydrogen chloride oxidation; chlorine which has not been separated off and remains in the gas stream would reduce the possible HCl conversion in the HCl oxidation reactor. Secondly, part of the uncondensed gas stream is discharged from the process in order to limit the accumulation of inert gases, in particular nitrogen and carbon dioxide. However, chlorine comprised in the purge gas stream increases the outlay for the after-treatment of the purge gas stream. The chlorine losses associated therewith also decrease the chlorine yield of the process.

The liquid hydrogen chloride stream can be produced in a simple way by condensation at from 10 to 25 bar using a conventional refrigeration plant at condensation temperatures of from −10 to −40° C. This is advantageously carried out in association with, for example, an isocyanate or polycarbonate plant, since the low proportion of inert gases of less than 10% by volume in the hydrogen chloride obtained as by-product in these plants allows simple condensation of the hydrogen chloride. Integration with a purification of hydrogen chloride by distillation is particularly advantageous since this gives hydrogen chloride having a relatively high purity in the vicinity of the dew point.

The HCl obtained as by-product in the polycarbonate or isocyanate plant is, in a process step of the process, compressed, purified, e.g. purified by distillation, and condensed. The liquefied HCl is, after depressurization, used for cooling in the isolation of chlorine after the HCl oxidation and is thereby vaporized. The gaseous HCl stream is divided according to operational requirements into a feed gas stream for the HCl oxidation and a recycle stream which is recirculated to the polycarbonate or isocyanate plant and liquefied again there.

In general, hydrogen chloride obtained as offgas stream in a process in which hydrogen chloride is formed as coproduct is used in the process of the invention. Such processes are, for example,
(1) the preparation of isocyanate from phosgene and amines,
(2) acid chloride production,
(3) polycarbonate production,
(4) the preparation of vinyl chloride from ethylene dichloride,
(5) the chlorination of aromatics.

The vaporized HCl stream does not have to be circulated in its entirety, i.e. all compressed and condensed again, but instead can be fed as gaseous starting material to the HCl oxidation. To provide an increased quantity of cold in the HCl oxidation plant, all or part of vaporized HCl can be compressed and condensed again. For example, the HCl gas stream can be recirculated to the HCl compression stage or HCl purification stage of a polycarbonate or isocyanate plant.

In general, the hydrogen chloride used as refrigerant has a purity of >95% by volume, preferably >99% by volume. Carbon dioxide and traces of carbon monoxide or nitrogen can be comprised as secondary constituents.

In an embodiment of the process of the invention, the liquid hydrogen chloride stream a is produced in a process for preparing polycarbonates. In a further embodiment of the process of the invention, the liquid hydrogen chloride stream a is produced in a process for preparing isocyanates.

In conjunction with a process for preparing isocyanates, WO04/056758 describes a process for the partial or complete fractionation of a mixture comprising hydrogen chloride and phosgene, possibly solvents, low boilers and inert gases as is usually obtained in the preparation of isocyanates by reaction of amines with phosgene. A description is given of the removal of phosgene in order to purify the hydrogen chloride obtained as by-product to such an extent that it can be passed to a further use. Here, phosgene is obtained as bottom product in a distillation column. Apart from the further purification of HCl by scrubbing with a suitable solvent, preferably the solvent of the isocyanate synthesis, as described in this application, it is likewise possible, in the case of appropriate conditions of pressure and temperature in the enrichment section of the column, to purify HCl further by distillation and obtain it as a liquid offtake stream at the top of the column. This can also be achieved by compression and subsequent distillation of the gas stream obtained.

In an embodiment of the process of the invention, at least part of the gaseous hydrogen chloride stream a′ is fed as stream b1 comprising hydrogen chloride to the oxidation zone in step b). This part is generally from 10 to 90% of the hydrogen chloride stream a.

In a further embodiment of the invention, at least part of the gaseous hydrogen chloride stream a′ is liquefied again and reused as coolant stream. This part is generally from 10 to 90% of the hydrogen chloride stream a.

In the oxidation step b), a stream b1 comprising hydrogen chloride is fed together with an oxygen-comprising stream b2 into an oxidation zone and catalytically oxidized.

At least part of the hydrogen chloride b1 introduced in step b) can originate from the refrigerant stream a which is vaporized in the chlorine separation step e).

In the catalytic process, hydrogen chloride is oxidized to chlorine by means of oxygen in an exothermic equilibrium reaction, producing water vapor. Customary reaction temperatures are in the range from 150 to 500° C., and customary reaction pressures are in the range from 1 to 25 bar. Furthermore, it is advantageous to use oxygen in superstoichiometric amounts. For example, a two- to four-fold oxygen excess is customary.

Suitable catalysts comprise, for example, ruthenium oxide, ruthenium chloride or other ruthenium compounds on silicon dioxide, aluminum oxide, titanium dioxide or zirconium dioxide as support. Suitable catalysts can be obtained, for example, by application of ruthenium chloride to the support and subsequent drying or drying and calcination. Suitable catalysts can also comprise, in addition to or instead of a ruthenium compound, compounds of other noble metals, for example gold, palladium, platinum, osmium, iridium, silver, copper or rhenium. Suitable catalysts can also comprise chromium (III) oxide.

Customary reaction apparatuses in which the catalytic oxidation of hydrogen chloride is carried out are fixed-bed or fluidized-bed reactors. The oxidation of hydrogen chloride can be carried out in a plurality of stages.

The catalytic oxidation of hydrogen chloride can be carried out adiabatically or preferably isothermally or approximately isothermally, batchwise, preferably continuously, as a fluidized- or fixed-bed process. It is preferably carried out in a fluidized-bed reactor at a temperature of from 320 to 450° C. and a pressure of from 2 to 10 bar.

When the reaction is carried out in a fixed bed, it is also possible to use a plurality of, i.e. from 2 to 10, preferably from 2 to 6, particularly preferably from 2 to 5, in particular 2 or 3, reactors connected in series with additional intermediate cooling. The oxygen can either or be introduced together with the hydrogen chloride upstream of the first reactor or the introduction can be distributed over the various reactors. This connection of individual reactors in series can also be combined in one apparatus.

Suitable heterogeneous catalysts are, in particular, ruthenium compounds or copper compounds on support materials which may also be doped; preference is given to optionally doped ruthenium catalysts. Suitable support materials are, for example, silicon dioxide, graphite, titanium dioxide having a rutile or anatase structure, zirconium dioxide, aluminum oxide or mixtures thereof, preferably titanium dioxide, zirconium dioxide, aluminum oxide or mixtures thereof, particularly preferably gamma- or alpha-aluminum oxide or mixtures thereof.

The supported copper or ruthenium catalysts can, for example, be obtained by impregnating the support material with aqueous solutions of CuCl₂ or RuCl₃ and optionally a promoter for doping, preferably in the form of their chlorides. Shaping of the catalyst can be carried out after or preferably before impregnation of the support material.

Promoters suitable for doping are alkali metals such as lithium, sodium, potassium, rubidium and cesium, preferably lithium, sodium and potassium, particularly preferably potassium, alkaline earth metals such as magnesium, calcium, strontium and barium, preferably magnesium and calcium, particularly preferably magnesium, rare earth metals such as scandium, yttrium, lanthanum, cerium, praseodymium and neodymium, preferably scandium, yttrium, lanthanum and cerium, particularly preferably lanthanum and cerium, or mixtures thereof.

Preferred promoters are calcium, silver and nickel. Particular preference is given to the combination of ruthenium with silver and calcium and of ruthenium with nickel as promoter.

The volume ratio of hydrogen chloride to oxygen at the reactor inlet is generally in the range from 1:1 to 20:1, preferably from 2:1 to 8:1, particularly preferably from 2:1 to 5:1.

In a step c), the product gas stream b3 is brought into contact with aqueous hydrochloric acid I in a phase contact apparatus and water and hydrogen chloride are partly separated off from the stream b3, leaving a gas stream b comprising hydrogen chloride, chlorine, water, oxygen, carbon dioxide and possibly inert gases. In this step, which can also be referred to as quench and absorption step, the product gas stream b3 is cooled and water and hydrogen chloride are at least partly separated off from the product gas stream b3 as aqueous hydrochloric acid. The hot product stream b3 is cooled by contacting with dilute hydrochloric acid I as quenching medium in a suitable phase contact apparatus, for example a packed column or tray column, a jet scrubber or a spray tower, with part of the hydrogen chloride being absorbed in the quenching medium. The quenching and absorption medium is hydrochloric acid which is not saturated with hydrogen chloride.

In general, the phase contact apparatus is operated with circulating hydrochloric acid I. In a preferred embodiment, at least part of the aqueous hydrochloric acid circulating in the phase contact apparatus, for example from 1 to 20%, is taken off from the phase contact apparatus and subsequently distilled to give gaseous hydrogen chloride and an aqueous hydrochloric acid II depleted in hydrogen chloride, with the hydrogen chloride being recirculated to step b) and at least part of the aqueous hydrochloric acid II being recirculated to the phase contact apparatus.

The gas stream c leaving the phase contact apparatus comprises chlorine, hydrogen chloride, water, oxygen, carbon dioxide and generally also inert gases. This can be freed of traces of moisture in a subsequent drying stage d) by contacting with a suitable desiccant. Suitable desiccants are, for example, concentrated sulfuric acid, molecular sieves, or hygroscopic adsorbents. A gas stream d which comprises chlorine, oxygen, carbon dioxide and possibly inert gases and is essentially free of water is obtained.

In a step e), the dried gas stream d is cooled and optionally compressed to give a cooled and optionally compressed stream e.

According to the invention, the dried gas stream d which has previously been optionally compressed and precooled is cooled by cooling using a liquid hydrogen chloride stream in one or more heat exchangers. The cooled stream e generally has a pressure in the range from 2 to 35 bar, preferably from 3 to 10 bar, and a temperature in the range from −80 to −10° C., preferably from −50 to −20° C.

The dried gas stream d is generally cooled in a number of stages and compressed. The dried and optionally compressed gas stream d can firstly be cooled by means of cooling water or cold water to a temperature of from about 40 to 5° C. The optionally compressed and precooled gas stream d can subsequently be cooled to the final temperature of generally from −80 to −10° C., preferably from −50 to −20° C., in one or more heat exchangers using liquid hydrogen chloride as refrigerant. Between the cold water cooling and the cooling by means of liquid hydrogen chloride, the compressed gas stream d can also be precooled by means of the unliquefied gas stream f1.

In a subsequent gas/liquid separation f), the stream e is separated into a gas stream f1 comprising chlorine, oxygen, carbon dioxide and possibly inert gases and a liquid stream f2 comprising chlorine, hydrogen chloride, oxygen and carbon dioxide.

In a step g), the liquid stream f2 is separated by distillation in a column into a chlorine stream g1 and a stream g2 consisting essentially of hydrogen chloride, oxygen and carbon dioxide. In a preferred embodiment, part of the hydrogen chloride is condensed at the top of the column and allowed to run back as runback into the column, as a result of which a stream g2 having a chlorine content of <1% by weight is obtained.

In a further optional step h, a substream which has been separated off as purge gas stream from stream f1 is brought into contact with a solution comprising sodium hydrogencarbonate and sodium hydrogensulfite having a pH of from 7 to 9, thus removing chlorine and hydrogen chloride from the gas stream.

The invention also provides for the use of liquid hydrogen chloride as refrigerant for cooling and optionally liquefying chlorine by indirect heat exchange in chlorine-producing processes.

Chlorine-producing processes are, for example, the heterogeneously catalytic oxidation of hydrogen chloride by means of oxygen or the electrochemical oxidation of hydrogen chloride (hydrogen chloride electrolysis).

The liquid hydrogen chloride can be used as refrigerant in a secondary cooling circuit and transfer heat to a primary cooling circuit using a heat exchanger, with the primary cooling circuit being cooled by a refrigeration machine, i.e. transfer its heat to the refrigeration machine and thus ultimately to the surroundings. As refrigerant for the primary cooling circuit, it is possible to use conventional refrigerants such as partially halogenated hydrocarbons.

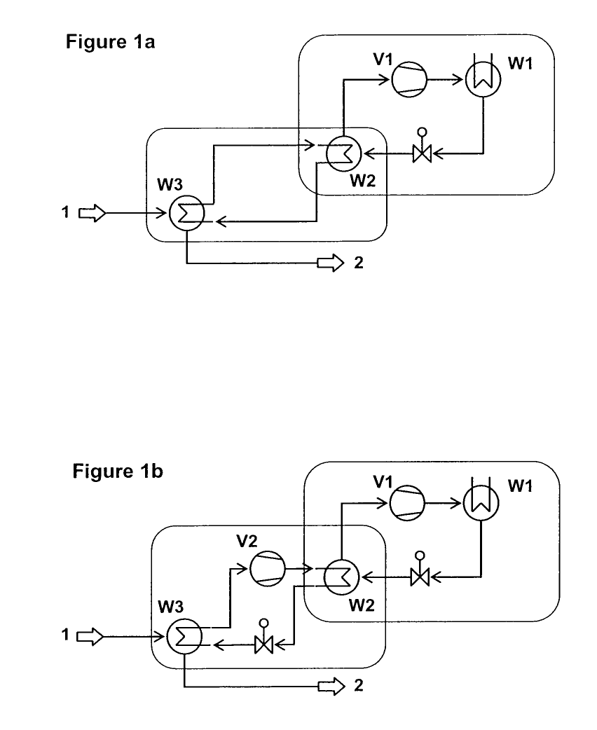

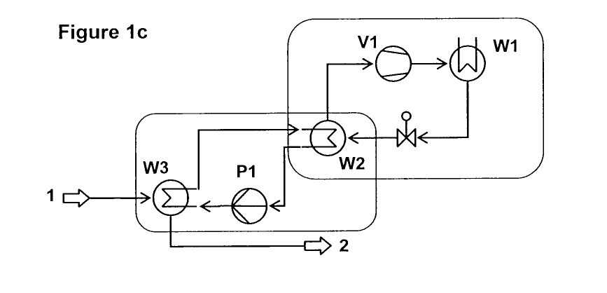

FIGS. 1a, b and c show, by way of example, schematic arrangements comprising a primary cooling circuit and a secondary cooling circuit operated using hydrogen chloride as refrigerant. The refrigeration machine operated using a conventional refrigerant, e.g. a partially halogenated hydrocarbon, comprises the apparatuses: refrigerant compressor V1, refrigerant condenser, e.g. water-cooled, W1, depressurization valve and the heat exchanger W2 shared with the secondary cooling circuit. The secondary cooling circuit comprises the heat exchangers W2 and W3, with the heat taken up from the process in the heat exchanger W3 being transferred via the heat exchanger W2 to the refrigerant of the refrigeration machine.

The stream denoted by 1 is the process stream which is obtained in chlorine production, is to be cooled and optionally is to be condensed, and the stream denoted by 2 is the cooled or condensed liquid process stream.

FIGS. 1a, b and c differ in the way in which the secondary cooling circuit is operated.

In FIG. 1a, HCl is vaporized in the heat exchanger W3 and condensed again in the heat exchanger W2. Transport of the gas or the liquid occurs purely convectively or hydraulically.

In FIG. 1b, HCl is, as in FIG. 1a, vaporized in the heat exchanger W3 and condensed again in the heat exchanger W2. Owing to the pressure differences between the heat exchangers W2 and W3, gaseous HCl has to be compressed by the compressor V2 on the way from W3 to W2. The pressure in W2 is regulated by the pressure regulating valve via which the condensed liquid HCl is depressurized on the way to heat exchanger W3.

The secondary cooling circuit in FIG. 1c is operated without a phase change using completely liquefied HCl. Liquid HCl is heated in the heat exchanger W3 only to the extent that the boiling point is not reached. The liquid is subsequently cooled in W2. Transport of the liquid HCl in the secondary cooling circuit is effected by means of the pump P1.

1. A process for preparing chlorine from hydrogen chloride, which comprises the steps
a) provision of a liquid hydrogen chloride stream a as refrigerant stream;
b) introduction of at least one stream b1 comprising hydrogen chloride and an oxygen-comprising stream b2 into a hydrogen chloride oxidation zone and catalytic oxidation of hydrogen chloride to chlorine, giving a product gas stream b3 comprising chlorine, water, oxygen, carbon dioxide and inert gases;
c) contacting of the product gas stream b3 with aqueous hydrochloric acid I in a phase contact apparatus and partial separation of water and hydrogen chloride from the stream b3, leaving a gas stream c comprising hydrogen chloride, chlorine, water, oxygen, carbon dioxide and possibly inert gases;
d) drying of the gas stream c to leave an essentially water-free gas stream d comprising hydrogen chloride, chlorine, oxygen, carbon dioxide and possibly inert gases;
e) partial liquefaction of the gas stream d by compression and cooling, giving an at least partly liquefied stream e;
f) gas/liquid separation of the stream e into a gas stream f1 comprising chlorine, oxygen, carbon dioxide, hydrogen chloride and possibly inert gases and a liquid stream f2 comprising hydrogen chloride, chlorine, oxygen and carbon dioxide and optionally recirculation of at least part of the gas stream f1 to step b);
g) separation of the liquid stream f2 into a chlorine stream g1 and a stream g2 consisting essentially of hydrogen chloride, oxygen and carbon dioxide by distillation in a column,
wherein the cooling and partial liquefaction of the gas stream d in step e) is effected by indirect heat exchange with the liquid hydrogen chloride stream a, resulting in at least part of the liquid hydrogen chloride stream a vaporizing and this part being obtained as a gaseous hydrogen chloride stream a′.

2. The process according to claim 1, wherein the liquid hydrogen chloride stream is under a pressure of from 1 to 30 bar and has a temperature of from −10 to −80° C.

3. The process according to claim 1, wherein at least part of the gaseous hydrogen chloride stream a′ is fed as stream b1 comprising hydrogen chloride into the hydrogen chloride oxidation zone.

4. The process according to claim 1, wherein at least part of the gaseous hydrogen chloride stream a′ is liquefied again and reused as refrigerant stream.

5. The process according to claim 1, wherein the liquid hydrogen chloride stream a is produced in a process for preparing polycarbonates or in a process for preparing isocyanates.

6. The process according to claim 5, wherein the liquid hydrogen chloride stream a is produced in the purification by distillation of hydrogen chloride obtained as by-product in the preparation of polycarbonates or the preparation of isocyanates.

7. A method of use of liquid hydrogen chloride as refrigerant for cooling and optionally liquefying chlorine by indirect heat exchange in chlorine-producing processes, comprising the step of transfering heat via a heat exchanger from a secondary cooling circuit to a primary cooling circuit, wherein liquid hydrogen is used as refrigerant in the second cooling circuit.

8. A method of use according to claim 7, wherein the chlorine-producing process is a process for the heterogeneously catalytic oxidation of hydrogen chloride or a process for electrochemical oxidation of hydrogen chloride.

9. A method of use according to claim 7, wherein a partially halogenated hydrocarbon is used as refrigerant in the primary cooling circuit.
